(19) United States
(12) Patent Application Publication
(10) Pub. No.: US 2012/0303263 A1
(43) Pub. Date: Nov. 29, 2012

(54) OPTIMIZATION OF NAVIGATION TOOLS USING SPATIAL SORTING

(75) Inventors: Mudassir Alam, Redmond, WA (US); Juan Pablo Candelas Gonzalez, Redmond, WA (US)

(73) Assignee: Microsoft Corporation, Redmond, WA (US)

(21) Appl. No.: 13/300,156

(22) Filed: Nov. 18, 2011

Related U.S. Application Data
(60) Provisional application No. 61/489,161, filed on May 23, 2011.

(51) Int. Cl. G01C 21/00

(52) U.S. Cl. 701/410; 701/533

(57) ABSTRACT

Digital map navigation applications for use with a mobile computing device are optimized using a spatial sorting method. Spatial sorting entails partitioning a digital map into tiles and maintaining information that links tiles to points on the route. When a particular map navigation application is invoked, a set of relevance rules are defined for that map application to determine which of the route points to process. This determination is made by extracting from the look-up table a subset of the full set of route points, based on the relevance rules. Because the subset of route points is processed instead of the original full set of route points, the mobile device is capable of efficiently handling a complex route that otherwise would entail considerable expenditure of processor time and use of computer memory to store and retrieve unnecessary data.

### CROSS REFERENCE TO RELATED APPLICATIONS

This patent application claims benefit of U.S. Provisional Patent Application No. 61/489,161, filed May 23, 2011, which is hereby incorporated by reference in its entirety.

### BACKGROUND

Computer-aided map navigation tools have achieved widespread acceptance. A user can find an address or directions with map navigation tools available at various Web sites. Some software programs allow a user to navigate over a map, zooming in towards the ground or zooming out away from the ground, or moving between different geographical positions. In cars, global positioning system (GPS) devices have provided rudimentary road navigation for years. More recently, map navigation software for cellular telephones and other mobile computing devices has allowed users to zoom in, zoom out, and move around a map that shows details about geographical features, town, city, county and state locations, roads, and buildings.

Navigation using a mobile computing device such as a mobile phone or a “smart phone” usually entails entering a destination, determining the present location of the device, plotting the present location and the destination as points on a digital map, displaying a route having intermediate route points between the present location and the destination, and updating progress along the route by tracking movement of the present location of the device along the displayed route. Typically, the display showing progress along the route is refreshed periodically, perhaps every few seconds, and the map is updated accordingly. While navigating, a user may zoom in or out, which triggers another re-fresh of the map display. Repeatedly updating and displaying the map information associated with navigation, especially for complex routes, is computationally demanding, requiring many mathematically intensive operations such as vector operations on floating point numbers, trigonometric calculations, and the like. Conventional methods step sequentially through each route point along the route, and perform such calculations at every step. This intense computational activity associated with navigation operations demands a high percentage of central processing unit (CPU) time, and tends to drain the battery of the mobile device quickly due to frequent activation of the GPS receiver and associated mapping functions.

One way to alleviate this computational burden might be to reduce the set of route points to be analyzed, by taking into account progress along the route, and discarding points that have been passed already. This method would offer slight optimization but it still operates with a large set of points in the worst case scenario, at the beginning of navigation. Another way is to use Kd-tree data structures to optimize the look-up process for route points. However, use of such trees increases complexity, resulting in a solution that, for n route points, runs at a rate that increases by order n(log n) instead of linearly. Thus, although use of the Kd-tree data structure may improve efficiency for a short route, it slows down performance exponentially as the number of route points increases. However, even with these enhancements, existing methods of navigation for mobile computing devices can be inefficient.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for rendering views of a digital map in which map navigation applications are optimized using a spatial sorting method to generate a reduced set of route points. The optimized method facilitates navigation along a prescribed route shown on a digital map. Spatial sorting begins by partitioning the digital map into a plurality of tiles, thereby segmenting the route. Next, the map data associated with the prescribed route is stored in the form of a route points vector, and a look-up table is populated with a set of keys, each key being associated with a different tile. When a particular map navigation application is invoked, a set of relevance rules are defined for that map application to determine which of the route points to process. This determination is made by extracting a subset of the full set of route points, based on the relevance rules. Because the subset of route points is processed instead of the original full set of route points, the mobile device is capable of efficiently handling a complex route that otherwise would entail considerable expenditure of processor time and use of computer memory to store and retrieve unnecessary data for irrelevant points of interest.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram illustrating an example mobile computing device in conjunction with which techniques and tools described herein may be implemented.

FIG. 2 is a block diagram illustrating an example software architecture for a map navigation tool that renders map views and list views.

FIGS. 3a and 3b are diagrams illustrating features of a generalized map view and generalized list view rendered using a map navigation tool.

FIGS. 4a-4c are example screenshots illustrating user interface features of list views rendered using a map navigation tool.

FIG. 5a is a screenshot of an example map onto which an example route has been superimposed.

FIG. 5b is a representation of an example world map onto which example coordinates are superimposed for LOD 3.

FIG. 6 is a representation of data structures that may be used to produce a subset of route points relevant to a particular location or region of the map shown in FIG. 5a.

FIG. 7 is a flow diagram of method steps performed when navigating a route on a mobile device using a map navigation tool configured with spatial sorting.

FIG. 8 is a diagram illustrating a case in which relevant route points lie outside a set of tiles, but a route connecting the points intersects the tiles.

FIG. 9 is a diagram illustrating a case in which relevant route points lie outside a set of tiles, but a route connecting the points lies along the edge of the tiles.

FIG. 10a is a diagram illustrating a case in which relevant route points lie outside a tile, but a route connecting the points intersects and re-enters the tile.

FIG. 10b is a diagram illustrating that an incorrect polyline (shown as dotted) can result if intermediate route points shown in FIG. 10a are omitted from the set of relevant route points.

FIG. 11a is a diagram of a tiled map in which tiles that intersect the vicinity of a user location are highlighted.

FIG. 11b is a diagram of the tiled map shown in FIG. 11a in which tiles neighboring a user location are highlighted.

FIG. 12a is a flow diagram of method steps carried out by a client mobile computing device configured to optimize map navigation using spatial sorting.

FIG. 12b is a flow diagram of method steps carried out by a remote server with which the client of FIG. 12a communicates in a client-server scenario.

FIG. 13 is a flow diagram of a subset of the method steps shown in FIG. 12a, that enable efficiently rendering a digital map on a mobile electronic device.

### DETAILED DESCRIPTION

### Example Mobile Computing Device

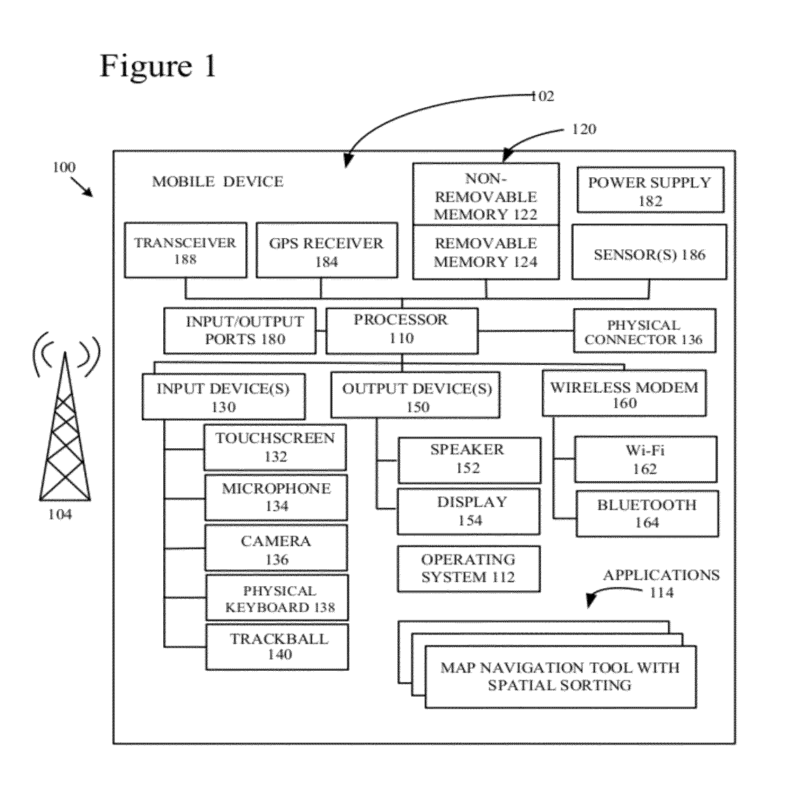

FIG. 1 depicts a detailed example of a mobile computing device (100) capable of implementing the techniques and solutions described herein. The mobile device (100) includes a variety of optional hardware and software components, shown generally at (102). In general, a component (102) in the mobile device can communicate with any other component of the device, although not all connections are shown, for ease of illustration. The mobile device can be any of a variety of computing devices (e.g., cell phone, smartphone, handheld computer, laptop computer, notebook computer, tablet device, netbook, media player, Personal Digital Assistant (PDA), camera, video camera, etc.) and can allow wireless two-way communications with one or more mobile communications networks (104), such as a Wi-Fi, cellular, or satellite network.

The illustrated mobile device (100) includes a controller or processor (110) (e.g., signal processor, microprocessor, ASIC, or other control and processing logic circuitry) for performing such tasks as signal coding, data processing, input/output processing, power control, and/or other functions. An operating system (112) controls the allocation and usage of the components (102) and support for one or more application programs (114) such as a map navigation tool that implements one or more of the innovative features described herein. In addition to map navigation software, the application programs can include common mobile computing applications (e.g., telephony applications, email applications, calendars, contact managers, web browsers, messaging applications), or any other computing application.

The illustrated mobile device (100) includes memory (120). Memory (120) can include non-removable memory (122) and/or removable memory (124). The non-removable memory (122) can include RAM, ROM, flash memory, a hard disk, or other well-known memory storage technologies. The removable memory (124) can include flash memory or a Subscriber Identity Module (SIM) card, which is well known in Global System for Mobile Communications (GSM) communication systems, or other well-known memory storage technologies, such as “smart cards.” The memory (120) can be used for storing data and/or code for running the operating system (112) and the applications (114). Example data can include web pages, text, images, sound files, video data, or other data sets to be sent to and/or received from one or more network servers or other devices via one or more wired or wireless networks. The memory (120) can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device (100) can support one or more input devices (130), such as a touch screen (132) (e.g., capable of capturing finger tap inputs, finger gesture inputs, or keystroke inputs for a virtual keyboard or keypad), microphone (134) (e.g., capable of capturing voice input), camera (136) (e.g., capable of capturing still pictures and/or video images), physical keyboard (138), buttons and/or trackball (140) and one or more output devices (150), such as a speaker (152) and a display (154). Other possible output devices (not shown) can include piezoelectric or other haptic output devices. Some devices can serve more than one input/output function. For example, touchscreen (132) and display (154) can be combined in a single input/output device.

The computing device 100 can provide one or more natural user interfaces (NUIs). For example, the operating system 112 or applications 114 can comprise speech-recognition software as part of a voice user interface that allows a user to operate the device 100 via voice commands. For example, a user's voice commands can be used to provide input to a map navigation tool.

A wireless modem (160) can be coupled to one or more antennas (not shown) and can support two-way communications between the processor (110) and external devices, as is well understood in the art. The modem (160) is shown generically and can include, for example, a cellular modem for communicating at long range with the mobile communication network (104), a Bluetooth-compatible modem (164), or a Wi-Fi-compatible modem (162) for communicating at short range with an external Bluetooth-equipped device or a local wireless data network or router. The wireless modem (160) is typically configured for communication with one or more cellular networks, such as a GSM network for data and voice communications within a single cellular network, between cellular networks, or between the mobile device and a public switched telephone network (PSTN).

The mobile device can further include at least one input/output port (180), a power supply (182), a satellite navigation system receiver (184), such as a Global Positioning System (GPS) receiver, sensors (186) such as an accelerometer, a gyroscope, or an infrared proximity sensor for detecting the orientation and motion of device 100, and for receiving gesture commands as input, a transceiver (188) (for wirelessly transmitting analog or digital signals) and/or a physical connector (190), which can be a USB port, IEEE 1394 (FireWire) port, and/or RS-232 port. The illustrated components (102) are not required or all-inclusive, as any of the components shown can be deleted and other components can be added.

The mobile device can determine location data that indicates the location of the mobile device based upon information received through the satellite navigation system receiver (184) (e.g., GPS receiver). Alternatively, the mobile device can determine location data that indicates location of the mobile device in another way. For example, the location of the mobile device can be determined by triangulation between cell towers of a cellular network. Or, the location of the mobile device can be determined based upon the known locations of Wi-Fi routers in the vicinity of the mobile device. The location data can be updated every second or on some other basis, depending on implementation and/or user settings. Regardless of the source of location data, the mobile device can provide the location data to map navigation tool for use in map navigation. For example, the map navigation tool periodically requests, or polls for, current location data through an interface exposed by the operating system (112) (which in turn may get updated location data from another component of the mobile device), or the operating system (112) pushes updated location data through a callback mechanism to any application (such as the map navigation tool) that has registered for such updates.

With the map navigation tool and/or other software or hardware components, the mobile device (100) implements the technologies described herein. For example, the processor (110) can update a map view and/or list view in reaction to user input and/or changes to the current location of the mobile device. As a client computing device, the mobile device (100) can send requests to a server computing device, and receive map images, distances, directions, other map data, search results or other data in return from the server computing device.

The mobile device (100) can be part of an implementation environment in which various types of services (e.g., computing services) are provided by a computing “cloud.” For example, the cloud can comprise a collection of computing devices, which may be located centrally or distributed, that provide cloud-based services to various types of users and devices connected via a network such as the Internet. Some tasks (e.g., processing user input and presenting a user interface) can be performed on local computing devices (e.g., connected devices) while other tasks (e.g., storage of data to be used in subsequent processing) can be performed in the cloud.

Although FIG. 1 illustrates a mobile device (100), more generally, the techniques and solutions described herein can be implemented with devices having other screen capabilities and device form factors, such as a desktop computer, a television screen, or device connected to a television (e.g., a set-top box or gaming console). Services can be provided by the cloud through service providers or through other providers of online services. Thus, the map navigation techniques and solutions described herein can be implemented with any of the connected devices as a client computing device. Similarly, any of various computing devices in the cloud or a service provider can perform the role of server computing device and deliver map data or other data to the connected devices.

### Example Software Architecture for Rendering of Map Data and Directions

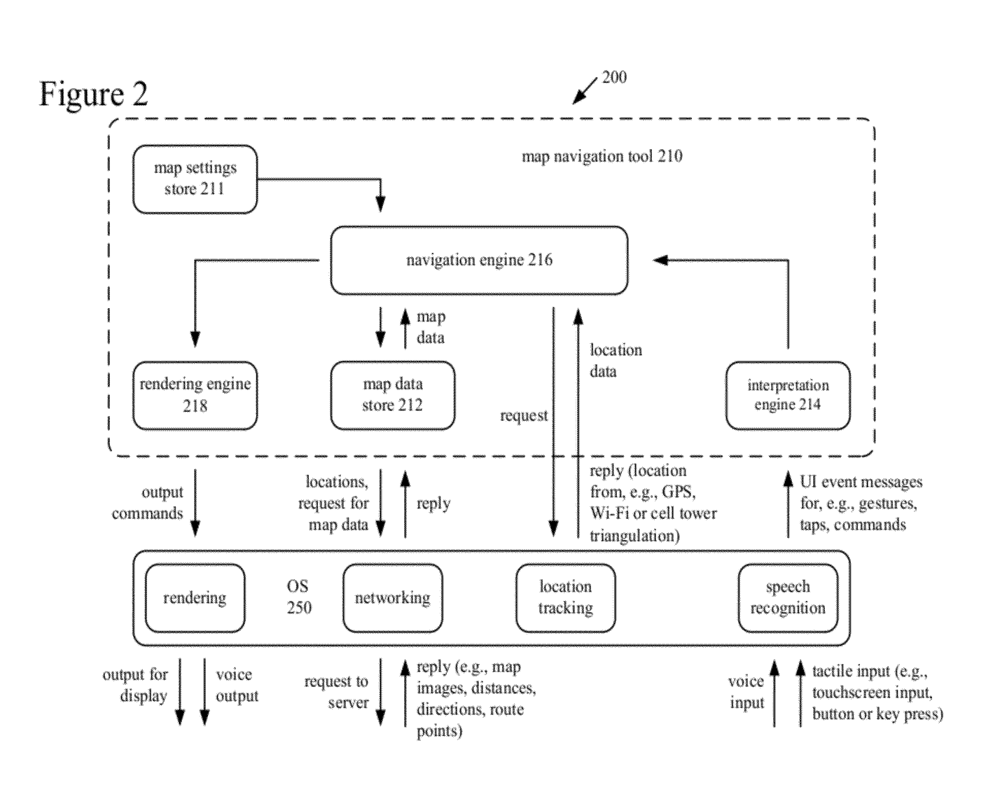

FIG. 2 shows an example software architecture (200) for a map navigation tool (210) that renders views of a map depending on user input and location data. A client computing device (e.g., smart phone or other mobile computing device) can execute software organized according to the architecture (200) to render map views, list views of directions for a route, or other views.

The architecture (200) includes a device operating system (OS) (250) and map navigation tool (210). In FIG. 2, the device OS (250) includes components for rendering (e.g., rendering visual output to a display, generating voice output for a speaker), components for networking, components for location tracking, and components for speech recognition. The device OS (250) manages user input functions, output functions, storage access functions, network communication functions, and other functions for the device. The device OS (250) provides access to such functions to the map navigation tool (210).

A user can generate user input that affects map navigation. The user input can be tactile input such as touchscreen input, button presses or key presses or voice input. The device OS (250) includes functionality for recognizing taps, finger gestures, etc. to a touchscreen from tactile input, recognizing commands from voice input, button input or key press input, and creating messages that can be used by map navigation tool (210) or other software. The interpretation engine (214) of the map navigation tool (210) listens for user input event messages from the device OS (250). The UI event messages can indicate a panning gesture, flicking gesture, dragging gesture, or other gesture on a touchscreen of the device, a tap on the touchscreen, keystroke input, or other UI event (e.g., from voice input, directional buttons, trackball input). If appropriate, the interpretation engine (214) can translate the UI event messages from the OS (250) into map navigation messages sent to a navigation engine (216) of the map navigation tool (210).

The navigation engine (216) considers a current view position (possibly provided as a saved or last view position from the map settings store (211)), any messages from the interpretation engine (214) that indicate a desired change in view position, map data and location data. From this information, the navigation engine (216) determines a view position and provides the view position as well as location data and map data in the vicinity of the view position to the rendering engine (218). The location data can indicate a current location (of the computing device with the map navigation tool (210)) that aligns with the view position, or the view position can be offset from the current location.

The navigation engine (216) gets current location data for the computing device from the operating system (250), which gets the current location data from a local component of the computing device. For example, the location data can be determined based upon data from a global positioning system (GPS), by triangulation between towers of a cellular network, by reference to physical locations of Wi-Fi routers in the vicinity, or by another mechanism.

The navigation engine (216) gets map data for a map from a map data store (212). In general, the map data can be photographic image data or graphical data (for boundaries, roads, etc.) at various levels of detail, ranging from high-level depiction of states and cites, to medium-level depiction of neighborhoods and highways, to low-level depiction of streets and buildings. Aside from photographic data and graphical data, the map data can include graphical indicators such as icons or text labels for place names of states, cities, neighborhoods, streets, buildings, landmarks or other features in the map. Aside from names, the map data can include distances between features, route points (in terms of latitude and longitude) that define a route between start and end locations, text directions for decisions at waypoints along the route (e.g., turn at NE 148^{th}), and distances between waypoints along the route. The map data can provide additional details for a given feature such as contact information (e.g., phone number, Web page, address), reviews, ratings, other commentary, menus, photos, advertising promotions, or information for games (e.g., geo-caching, geo-tagging). Links can be provided for Web pages, to launch a Web browser and navigate to information about the feature.

The organization of the map data depends on implementation. For example, in some implementations, different types of map data (photographic image data or graphical surface layer data, text labels, icons, etc.) are combined into a single layer of map data at a given level of detail. Up to a certain point, if the user zooms in (or zooms out), a tile of the map data at the given level of detail is simply stretched (or shrunk). If the user further zooms in (or zooms out), the tile of map data at the given level of detail is replaced with one or more other tiles at a higher (or lower) level of detail. In other implementations, different types of map data are organized in different overlays that are composited during rendering, but zooming in and out are generally handled in the same way, with overlapping layers stretched (or shrunk) to some degree, and then replaced with tiles at other layers.

The map data store (212) caches recently used map data. As needed, the map data store (212) gets additional or updated map data from local file storage or from network resources. The device OS (250) mediates access to the storage and network resources. The map data store (212) requests map data from storage or a network resource through the device OS (250), which processes the request, as necessary requests map data from a server and receives a reply, and provides the requested map data to the map data store (212).

For example, to determine directions for a route, the map navigation tool (210) provides a start location (typically, the current location of the computing device with the map navigation tool (210)) and an end location for a destination (e.g., an address or other specific location) as part of a request for map data to the OS (250). The device OS (250) conveys the request to one or more servers, which provide surface layer data, route points that define a route, text directions for decisions at waypoints along the route, distances between waypoints along the route, and/or other map data in reply. The device OS (250) in turn conveys the map data to the map navigation tool (210).

As another example, as a user travels along a route, the map navigation tool (210) gets additional map data from the map data store (212) for rendering. The map data store (212) may cache detailed map data for the vicinity of the current location, using such cached data to incrementally change the rendered views. The map navigation tool (210) can pre-fetch map data along the route, or part of the route. Thus, as the rendered map views are updated to account for changes to the current location, the map navigation tool (210) often updates the display without the delay of requesting/receiving new map data from a server. As needed, the map data store (212) requests additional map data to render views.

The rendering engine (218) processes the view position, location data and map data, and renders a view of the map. Depending on the use scenario, the rendering engine (218) can render map data from local storage, map data from a network server, or a combination of map data from local storage and map data from a network server. In general, the rendering engine (218) provides output commands for the rendered view to the device OS (250) for output on a display. The rendering engine (218) can also provide output commands to the device OS (250) for voice output over a speaker or headphones.

The exact operations performed as part of the rendering depend on implementation. In some implementations, for map rendering, the tool determines a field of view and identifies features of the map that are in the field of view. Then, for those features, the tool selects map data elements. This may include any and all of the map data elements for the identified features that are potentially visible in the field of view. Or, it may include a subset of those potentially visible map data elements which are relevant to the navigation scenario (e.g., directions, traffic). For a given route, the rendering engine (218) graphically connects route points along the route (e.g., with a highlighted color) to show the route and graphically indicates waypoints along the route. The tool composites the selected map data elements that are visible (e.g., not obscured by another feature or label) from the view position. Alternatively, the tool implements the rendering using acts in a different order, using additional acts, or using different acts.

In terms of overall behavior, the map navigation tool can react to changes in the location of the computing device and can also react to user input that indicates a change in view position, a change in the top item in a list of directions for a route, or other change. For example, in response to a finger gesture or button input that indicates a panning instruction on the map, or upon a change to a previous item or next item in a list of directions for a route, the map navigation tool can update the map with a simple, smooth animation that translates (shifts vertically and/or horizontally) the map. Similarly, as the location of the computing device changes, the map navigation tool can automatically update the map with a simple translation animation. (Or, the map navigation tool can automatically re-position and re-render an icon that indicates the location of the computing device as the location is updated.) If the change in location or view position is too large to be rendered effectively using a simple, smooth translation animation, the map navigation tool can dynamically zoom out from at first geographic position, shift vertically and/or horizontally to a second geographic position, then zoom in at the second geographic position. Such a dynamic zoom operation can happen, for example, when a phone is powered off then powered on at a new location, when the view position is re-centered to the current location of the device from far away, when the user quickly scrolls through items in a list of directions for a route, or when the user scrolls to a previous item or next item in the list of directions that is associated with a waypoint far from the current view position. The map navigation tool can also react to a change in the type of view (e.g., to switch from a map view to a list view, or vice versa), a change in details to be rendered (e.g., to show or hide traffic details).

Alternatively, the map navigation tool (210) includes more or fewer modules. A given module can be split into multiple modules, or different modules can be combined into a single layer. For example, the navigation engine can be split into multiple modules that control different aspects of navigation, or the navigation engine can be combined with the interpretation engine and/or the rendering engine. Functionality described with reference to one module (e.g., rendering functionality) can in some cases be implemented as part of another module.

### Example Map Navigation UI and Screenshots

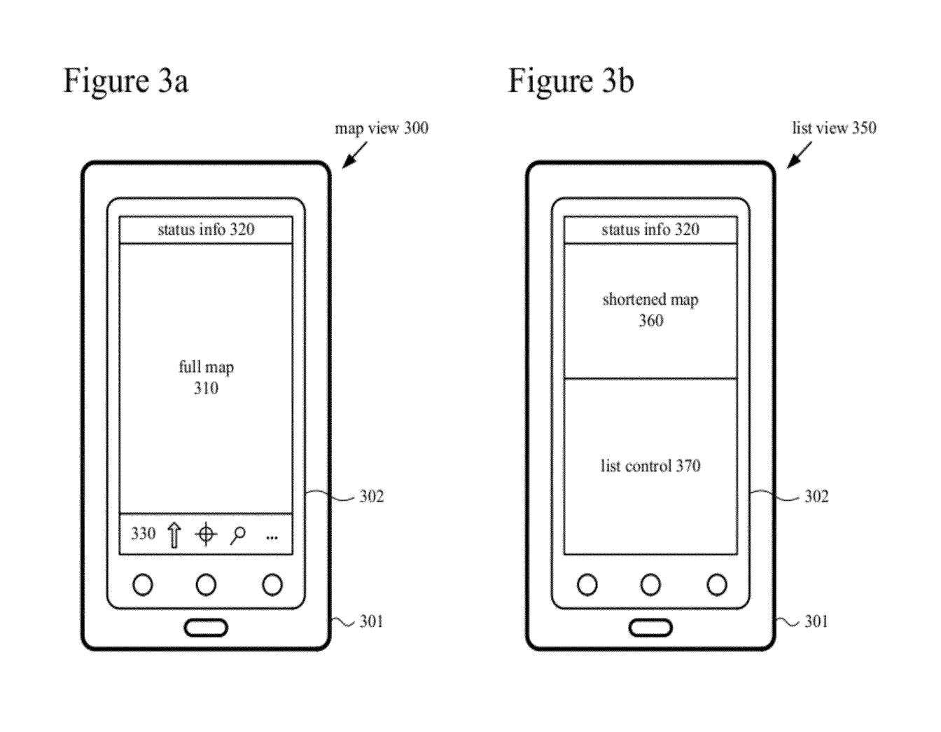

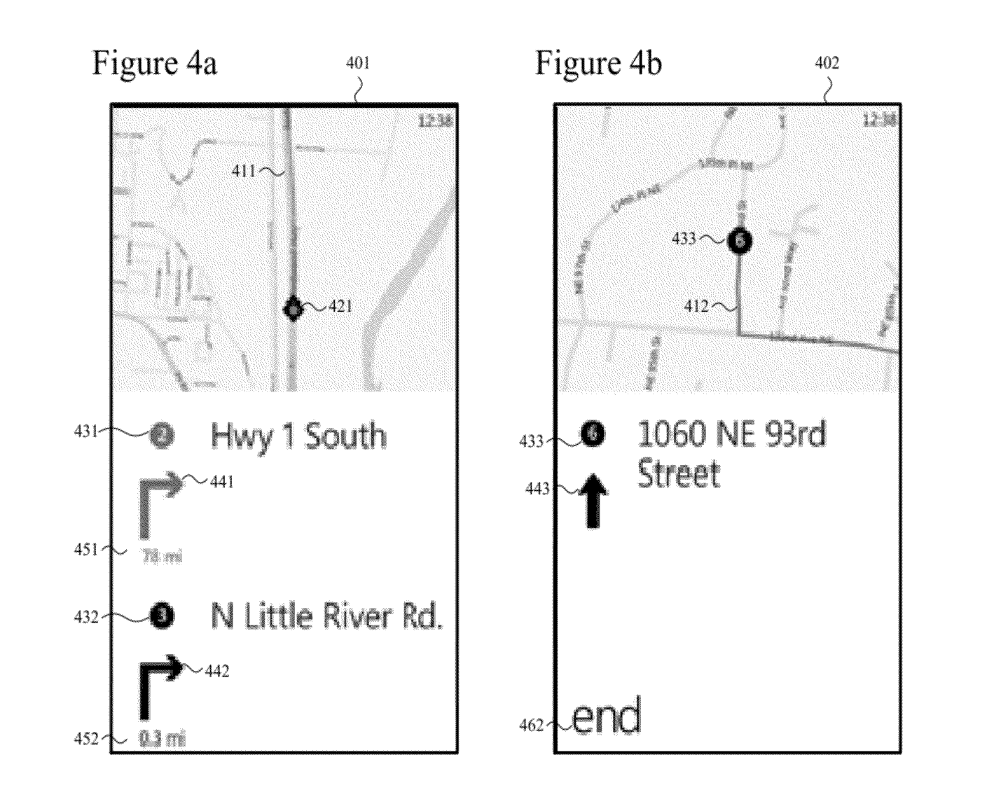

FIGS. 3a and 3b illustrate a generalized map view (300) and generalized direction list view (350), respectively, rendered using a map navigation tool of a mobile computing device (301). FIGS. 4a-4c show example screenshots (401, 402, 403) of a list view of a map navigation UI.

The device (301) includes one or more device buttons. FIGS. 3a and 3b show a single device button near the bottom of the device (301). The effect of actuating the device button depends on context. For example, actuation of the device button causes the device (301) to return to a home screen or start screen from the map navigation tool. Alternatively, the device (301) includes no device buttons.

The device (301) of FIGS. 3a and 3b includes a touchscreen (302) with a display area and three touchscreen buttons: The effect of actuating one of the touchscreen buttons depends on context and which button is actuated. For example, one of the touchscreen buttons is a search button, and actuation of the search button causes the device (301) to start a Web browser at a search page, start a search menu for contacts or start another search menu, depending on the point at which the search button is actuated. Or, one of the touchscreen buttons is a “back” button that can be used to navigate the user interface of the device. Alternatively, the device includes more touchscreen buttons, fewer touchscreen buttons or no touchscreen buttons. The functionality implemented with a physical device button can be implemented instead with a touchscreen button, or vice versa.

In the display area of the touchscreen (302), the device (301) renders views. In FIG. 3a, as part of the map view (300), the device (301) renders a full map (310) and status information (320) that overlays the top of the full map (310). The status information (320) can include time, date, network connection status and/or other information. The device (301) also renders a control section (330) that includes map navigation buttons, which depend on implementation of the map navigation tool. FIG. 3a shows a “directions” button (arrow icon), “re-center” button (crosshairs icon) and “search” button (magnifying glass icon). Actuation of the “directions” button causes the device (301) to open menu for keystroke input for a destination location. Actuation of the “center” button causes the device (301) to align the view position over the current location of the device (301). Actuation of the “search” button causes the device (301) to open menu for keystroke input for a search for a location or locations. Other buttons/controls can be accessed by actuating the ellipses, such as buttons/controls to clear the map of extra data, show/hide photographic image details, show/hide traffic data, show/hide route directions, change settings of the map navigation tool such as whether voice instructions are input or whether orientation of the view changes during progress along the route, etc. Alternatively, the device includes more map navigation buttons, fewer map navigation buttons or no map navigation buttons.

In FIG. 3b, as part of the list view (350), the device (301) renders a shortened map (360), status information (320) that overlays the top of the shortened map (360), and a list control (370). The shortened map (360) shows map details as in the full map (310) but also shows graphical details of at least part of a route between a start location and end location. The list control (370) shows text details and icons for directions along the route. FIGS. 4a-4c show example screenshots (401, 402, 403) of list views, each including a shortened map (360) and list control (370) as well as status information (320) (namely, time) that overlays the shortened map (360).

The screenshots (401, 402, 403) in FIGS. 4a-4c show different list views for a route between a start location and a destination. In the screenshot (401) of FIG. 4a, a graphical icon (421) shows the current user location along the route in the map portion of the list view. Part of the route (411) is shown in a highlighted color relative to the rest of the map data. The list control of the screenshot (401) includes waypoint icons (431, 432) and text details for waypoints along the route. Items in the list of direction are organized as waypoints, which represent points at which the user is given specific directions to turn, continue straight, take an exit, etc. Below the waypoint icons (431, 432), direction icons (441, 442) graphically represent the active part of the directions, e.g., to turn continue straight, take and exit associated with the respective waypoints. Distance values (451, 452) indicate the distance between waypoints (as in the distance (452) between waypoints 2 and 3) or distance between the current location and the upcoming waypoint (as in the distance (451) to waypoint 2).

The color of the waypoint icons (441, 442), text details, direction icons (441, 442) and distance values (451, 452) can change depending on the status of progress along the route. In FIG. 4a, the waypoint icon (431), text and direction icon (441) for waypoint 2 are rendered in an accent color to indicate waypoint 2 is the upcoming item in the list of directions. On the other hand, the waypoint icon (432), associated text and direction icon (442) for waypoint 3 are rendered in a neutral color to indicate waypoint 3 is further in the future.

The screenshot (402) of FIG. 4b shows the list view after the user scrolls to the end of the list of directions, which is graphically represented with text (462). Waypoint icons (433) represent a final waypoint in the map portion and list control of the list view. The map portion highlights part (412) of the route graphically. In the list control, the waypoint icon (433) is followed by text associated with the waypoint and a direction icon (443), but not a distance value since the waypoint is the final waypoint. The waypoint icon (433), associated text and direction icon (443) for the final, future waypoint are rendered in a neutral color.

The screenshot (403) of FIG. 4c shows the list view after the user scrolls back to the start of the list of directions, which is graphically represented with text (461). The map portion shows part (413) of the route graphically, but the completed part of the route is grayed out.

Waypoint icons (434) represent an initial waypoint in the map portion and list control of the list view, and are also grayed out to show that the initial waypoint has been passed. Another waypoint icon (435) represents a subsequent waypoint. In the list control, space permitting, the waypoint icons (434, 435) are followed by text associated with the waypoints and direction icons (444), also grayed out, but not distance value since the waypoints have been passed. The list control also includes transit mode icons (472) that the user can actuate to switch between modes of transit (e.g., walking, car, bus).

### Optimization of Navigation Tools Using Spatial Sorting

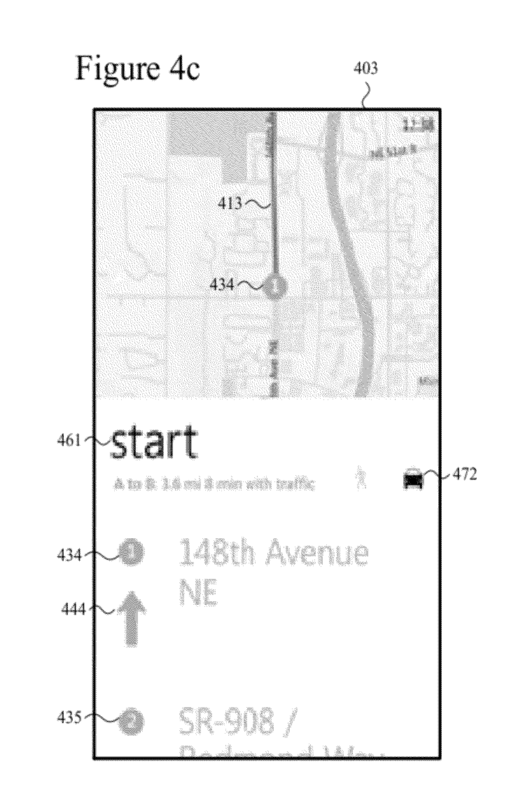

Referring to FIG. 5a, an exemplary regional map (500) is shown, along with an exemplary prescribed (i.e., pre-determined, or already calculated) route (510) for navigation, wherein the route begins at point A (520) in Seattle, Wash., and extends southward toward a destination (530) located southwest of Tacoma, e.g., Fort Lewis, Wash. The exemplary route (510) might have, for example, a few hundred route points, while a route that covers thousands of miles, say between Seattle and Miami, might have several thousand route points. Although in general, longer routes require more computation than shorter routes, the number of route points depends on the complexity of the route, as opposed to the length of the route. For example, a straight line segment of a route could be represented, in some situations, by two points regardless of its length. Thus, a short, winding route can potentially be more complex, and therefore more computationally demanding, than a long straight route. Processing (i.e., maintaining the status of, and rendering) all possible points on the regional map (500) is generally not feasible, especially while navigating a complex route. A method of spatially sorting route points by relevance to a particular navigation tool (e.g., a map program implemented on a smart phone) optimizes the use of computing resources.

A first step in the spatial sorting method is to partition the regional map (500) into tiles, thereby also segmenting the route (510). Tiles generally may have any polygonal shape, and they need not be uniform. Likewise, route segments, or polylines, may be of arbitrary length, and need not be uniform. In the example shown in FIG. 5a, twelve square tiles (531)-(542) are demarcated by dotted lines.

The tiles (531)-(542) may be assigned row and column indices or “tile identification (ID) coordinates” according to a certain generalized map implementation known as the Bing™ Maps Tile System. Bing™ Maps provides a standardized map projection, a set of coordinate systems, and an addressing scheme for use by developers of various mapping applications. To ensure that aerial images from different sources are compatible, Bing™ Maps uses a single two-dimensional map projection of the entire world, (for example, the “Mercator” projection of a world map (550) shown in FIG. 5b), and partitions the world map (550) at different levels of detail (LOD). Depending on the zoom level that needs to be displayed, the level of detail (LOD) varies from LOD 1, which displays a world map at a ground resolution of about 78,000 meters per pixel (at the equator), to LOD 23, the highest level of detail, which displays a world map at a ground resolution of about 0.02 meters per pixel. (However, in other implementations, different designations for zoom levels can be used.) Each tile on the world map (550) is given XY tile-ID coordinates ranging from (0,0) in the upper left corner of the map to (2^{LOD}−1, 2^{LOD}−1) in the lower right corner of the map. By way of example, coordinates for LOD 3 which range from (0,0) to (7,7) are shown in FIG. 5b.

In a specific implementation, for purposes of spatial sorting, partitioning of the world map (550) is done for all LODs up to LOD 10, (which has a ground resolution of about 153 meters per pixel) so that a tile grid and associated XY coordinates may be calculated for a particular LOD. Zooming in on a region of interest within the partitioned world map (550) then produces the tiled regional map shown in FIG. 5a. Tests of the spatial sorting optimization method have determined that zoom levels higher than LOD 10 can use the LOD 10 tiles with good performance results.

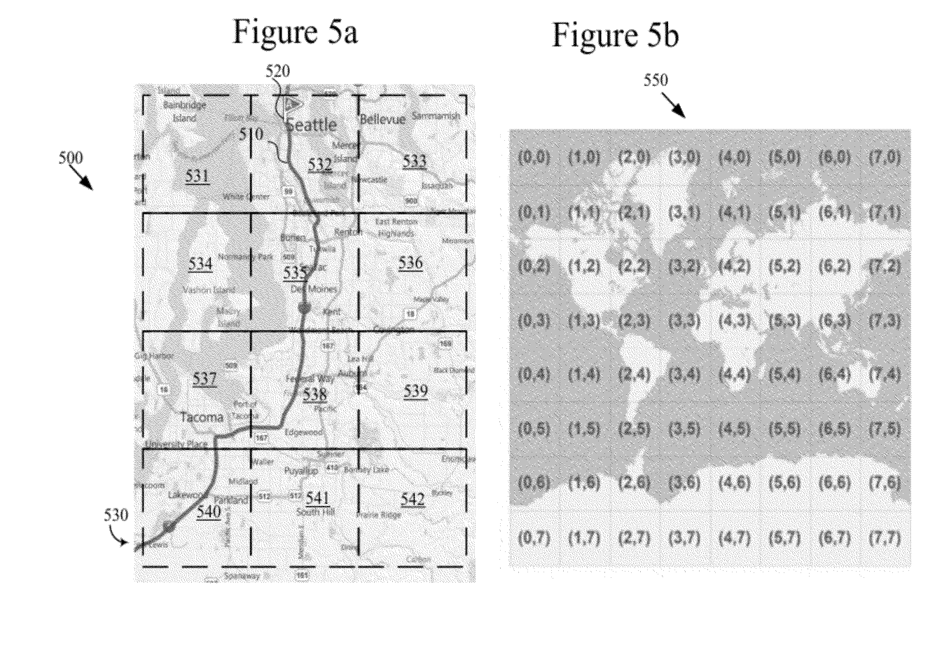

The next step in optimization by spatial sorting is to compute, for each tile that intersects the route (510), a list of corresponding route points of relevance using data structures (600), shown in FIG. 6. The data structures (600) include a look-up table (610), a list of relevant route points (660) for each tile entry in the look-up table (610), and a comprehensive route points vector (630) stored as, for example, a flat array. According to the spatial sorting method described herein, the look-up table (610) accesses the route points vector (620) via the list of relevant route points (660). The route points vector (620) can be generated externally and imported into the code that implements spatial sorting; whereas the look-up table (610) and the list of relevant route points (660) are both generated during the process of spatial sorting.

The look-up table (610) may be implemented as a type of “hash map” or “hash table,” containing an array of keys in which each key corresponds to a tile that is relevant to the route. Thus, the look-up table (610) is route-specific. Individual keys within look-up table (610) may be indexed by an LOD value (640) and tile-ID coordinates (650). For example, for the map (500) and the route (510) shown in FIG. 5a, tile (532) at the beginning of the route (510) has indices (10,1,0) corresponding to LOD 10 and X-Y tile ID coordinates (1,0); tile (535) has indices (10,1,1) corresponding to LOD 10 and X-Y tile ID coordinates (1,1); and tile (540) at the route destination has indices (10,0,3) corresponding to LOD 10 and X-Y tile ID coordinates (0,3). Thus, in the example, the look-up table (610) includes five entries for the five tiles that are relevant to the route (510).

Route points vector (620) contains latitude and longitude (“lat/long”) values (630) corresponding to a set of available route points along a route. In some implementations, the values (630) correspond to a full set of the route points (i.e., all of the route points) along a route, and can be downloaded from a map service such as for example, Bing!™ or Google Maps™. Thus, the route points vector (620) is route-specific. Route points can include any location along the route (510) as well as points of interest (POIs) on or near the route such as, for example, businesses, transport stations, tourist destinations, and the like. Once look-up table (610) is set up, the map application (114) can be configured to query table (610) for a given list of tile-IDs, and to extract a subset of the route points vector (620) according to a set of rules for determining relevance. Such a query then can be programmed to return a list of relevant route points (660) corresponding to a particular tile, for example, the tile in which the mobile device is currently located. The list of relevant route points (660) is stored in a separate data structure (e.g., a linked list or array) in which route points are represented by their index in the route points vector (620) rather than by a lat/long pair. Thus, the list of relevant route points (660) is tile-specific. Using these representations, route (510) may be segmented so that an abbreviated list of relevant route points (660), along a route segment within a tile, is sent to the processor (110) by the map application (114) instead of the entire route points vector (620) being processed unnecessarily. For example, for the route (510) shown in FIG. 5a, suppose there are a total of 480 route points in the route points vector (620), and that these points fall within tiles (532), (535), (538), (537), and (540). Suppose 100 of the 480 route points fall within tile (532), numbered 0-99, and 44 route points fall within tile (535), numbered 99-143, wherein route point 99 is located on the border between tiles (532) and (535) and is considered relevant to both tiles. Then the list of relevant route points (660) for tile (535) identifies route points 99-143 as relevant, so that this subset of points may be extracted from the Route Points Vector (620) for processing. Thus, processing all 480 route points is avoided when only the area within tile (535) is of current interest for immediate navigation.

For most map applications (114), limiting the number of route points processed to those within one or several tiles results in a significant efficiency benefit. A more complex route having more associated route points achieves a greater efficiency benefit from spatial sorting. To further reduce the memory footprint of the data structures (600), a method of route generalization can be used to zoom out, when it is appropriate, to an LOD at or below LOD 8, so that the subset of relevant route points is further limited.

Embodiments of this method of spatial sorting may be adapted for different map applications, or “use cases,” that need to determine which route points or segments are relevant to various locations or regions. Different use cases may include, for example, (a) a map application (114) that renders a route on a map, (b) a map application (114) that determines a user's position relative to a route, or (c) a map application (114) that snaps a user's current location to a route. Depending on the application, more or fewer tiles may be needed, and a set of customized rules for relevance are thus defined accordingly, based on the nature of the use. Many other use cases may also benefit from the optimization techniques presented herein.

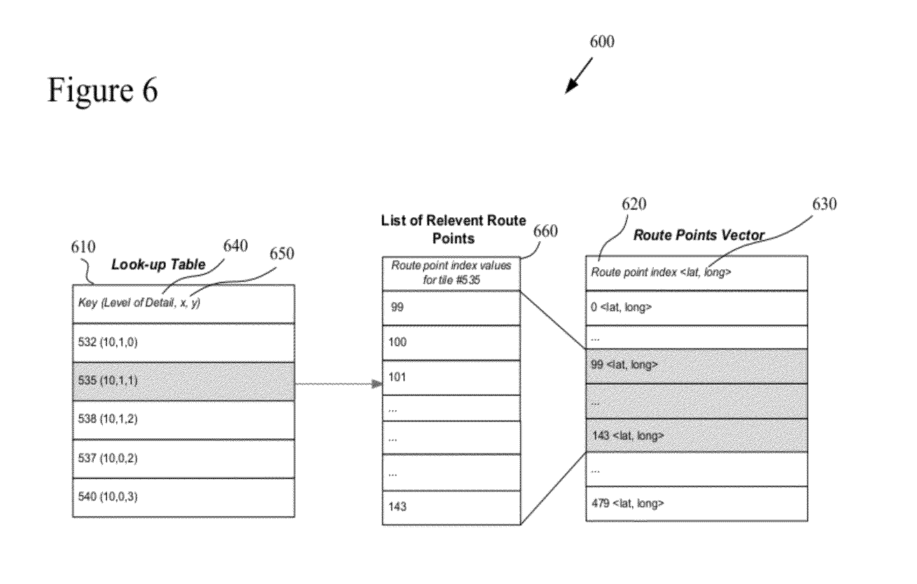

With reference to FIG. 7, a general method of navigation using spatial sorting is shown, wherein the steps of the navigation method are performed by the mobile device (100) when running the software applications (114) that include a map navigation tool configured with a spatial sorting feature. In response to a user request, for example, to search for a location or to provide directions to a destination, the mobile device first determines its current location (710) as described above. Map data describing the environs of the current location are then selected (720) and rendered for display on the mobile device (100) using spatial sorting optimization (730). The current location can be indicated by, for example, a dot or another location identifier superimposed onto the map display, thereby tracking progress along the route (740). Navigation steps (710)-(740) are then repeated until the destination is reached.

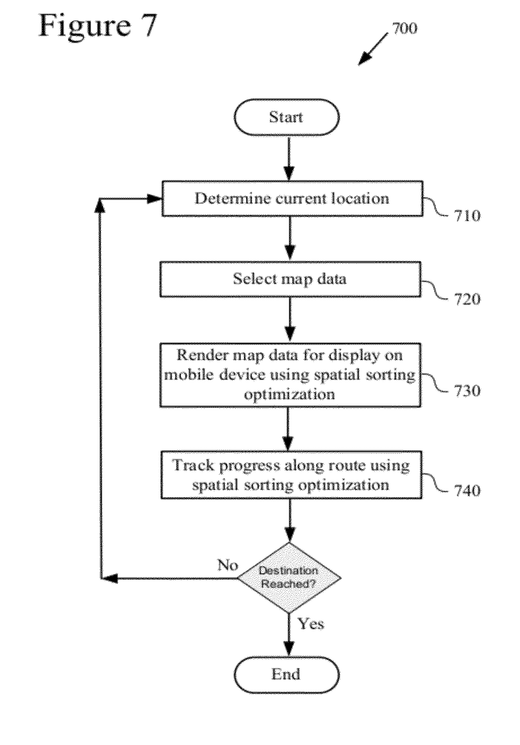

For purposes of illustration, details are presented for adapting spatial sorting to facilitate efficiently rendering a route on a map. For each tile on the map, the spatial sorting method determines which of the route points within or near each tile are to be rendered. It may not be necessary to render every route point that is located within the boundaries of the tile, but if the route intersects a tile, some segment of the route will be rendered. Likewise, if a route point lies close to a tile boundary but not inside it, the route point may still be relevant to that tile. For example, FIG. 8 shows a map portion (800) comprising three tiles (801), (802), and (803), in which two route points (810) and (820) are shown outside the tiles, but a route (830) connecting route points (810 and 820) intersects each one of tiles (801)-(803). Route points (810) and (820 thus may be considered relevant to each tile (801)-(803) for rendering purposes.

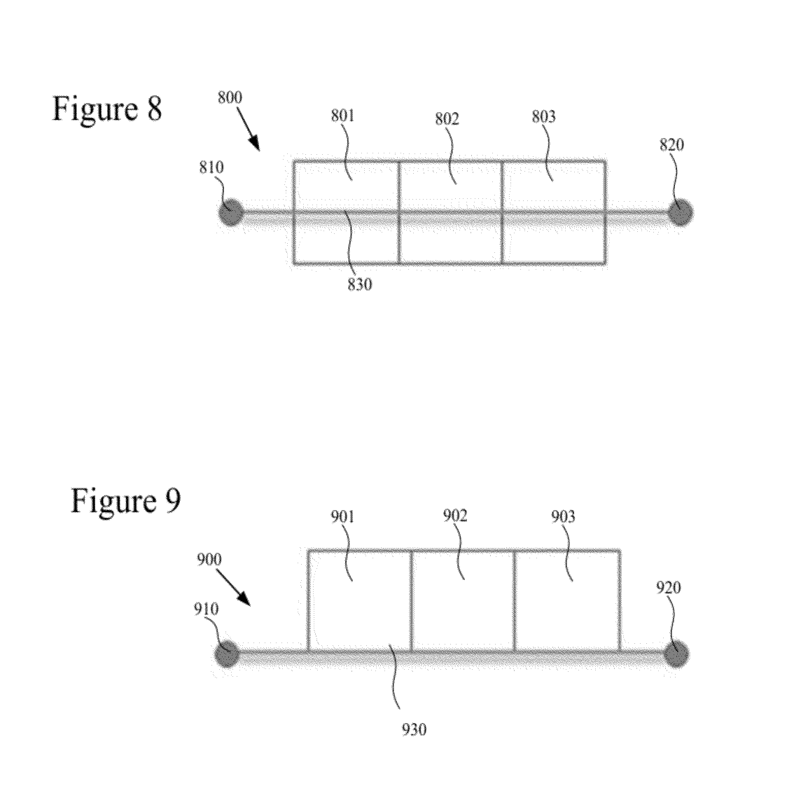

FIG. 9 shows a similar map portion (900) in which route points (910) and (920) are connected by a route (930) that intersects the edges of tiles (901)-(903). In this case as well, route points (910) and (920) may be considered relevant to each of tiles (901)-903) for rendering purposes, e.g., if it is necessary to render the route using a larger width “brush.”

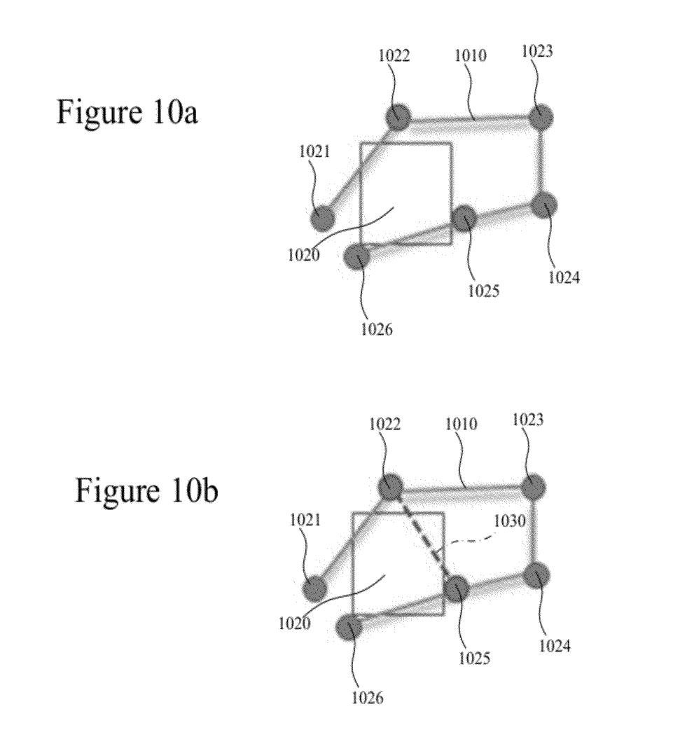

As a third example, FIG. 10a shows a certain drawing scenario in which a route (1010) leaves and re-enters the same tile (1020)—a common scenario for road exit ramps. In the case shown, none of the six route points (1021)-(1026) lies within the boundaries of tile (1020), yet all six route points are deemed to be relevant, including intermediate points (1023) and (1024), without which drawing a polyline (1030) for tile (1020) yields incorrect results, as indicated by the dotted line segment shown in FIG. 10b.

Generalizing upon the cases depicted in FIGS. 8-10, a new set of relevance rules for rendering points on a map may be adopted to encompass these types of situations. Depending on the implementation, one or more of the following rules can be applied, separately or in combination with other rules:
a) Instead of evaluating the location of the actual route points relative to the tiles, a route segment, or a line connecting adjacent points, may be used to establish relevance to a tile. If a route segment is determined to be relevant, then route points within that segment are deemed to be relevant.
b) Points in the vicinity of a tile may be considered relevant to that tile, wherein “vicinity” may be defined by a distance equal to or slightly larger than the maximum width of the rendered route.
c) If a route re-enters a tile, all intermediate points are considered relevant to that tile.
   A performance analysis of a specific implementation of the spatial sorting method for the case of route-rendering is summarized in Table I. The cost of implementing the look-up table (610) is expressed in terms of the memory requirements to store the information in the data structures (600) and the execution time needed to populate the table. The data shown in Table I demonstrates that these resource requirements are so small that they are practically negligible.

TABLE I
Performance Analysis of Spatial Sorting for use in Route Rendering

| | Average Route | | Very Long Route |
|---|---|---|---|
| | (Sammamish to | Long Route | (Tokyo to |
| | Bothell) | (Seattle to Miami) | Cape Town) |
| Memory (kB) | 4 | 443 | 1138 |
| Execution time to | 5 | 368 | 1198 |
| populate table | | | |
| (ms) | | | |

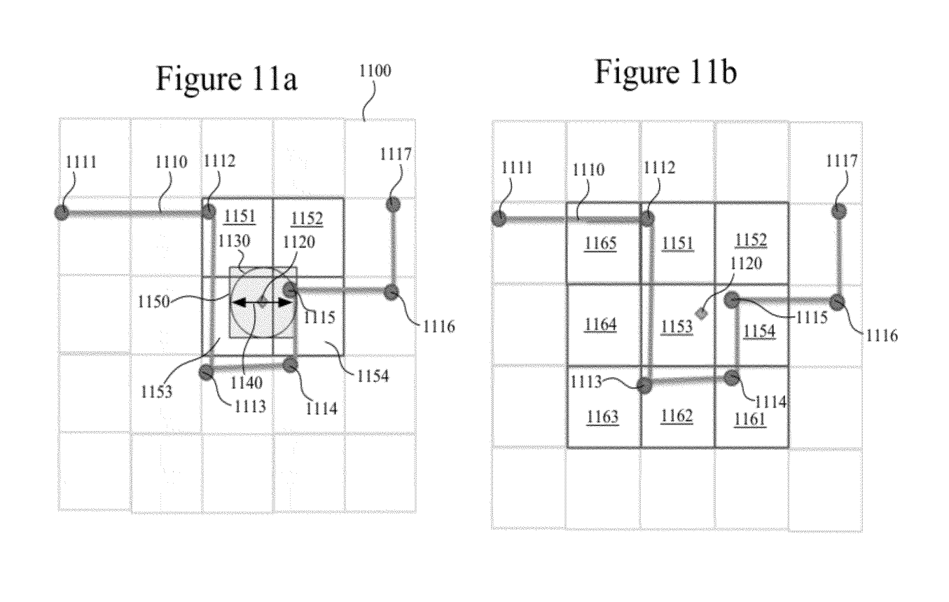

Another mapping application, or “use case,” that benefits from the spatial sorting method described above is determining a user's position relative to a route, in a navigation/tracking scenario. Because of inaccuracies in GPS data, if the user's current location is within a certain threshold, the location needs to be “snapped” to a route or route segment. This is necessary for detecting the next turn and calculating the distance to it. Snap candidates are determined by evaluating route points that are close to the user's location, and ascertaining which segment of the route is a candidate for a snap. Given a user's location, a set of relevance rules appropriate for a “snap-to-route” application can be understood via illustrations shown in FIGS. 11a-11b. A representative tiled map (1100) includes a route (1110) and seven route points (1111)-(1117). A pre-determined user location (1120) is indicated by a dot. A vicinity threshold (1130) around user location (1120) is defined by a circle (1132) of diameter (1140). It is typically advantageous for diameter (1140) to be larger than the snap threshold, for example by a factor of 2×. The circle (1132) may be inscribed within a vicinity square (1150), of a dimension equal to diameter (1140). The vicinity square (1150) then defines the vicinity of user location (1120).

Once the vicinity of user location (1120) is known, tiles at a resolution given by LOD 10 may be identified that intersect with the vicinity square (1150). In FIG. 11a there are four such intersecting tiles, (1151)-(1154), outlined in bold. Tile-ID coordinates corresponding to tiles (1151)-(1154) are then used as keys in the look-up table (610) to extract relevant route points (660) according to relevance rules (e.g., rules (a)-(c), described above) for rendering a map. A subset of route points to be evaluated is formed by combining the relevant route points for all four tiles. Thus, in the example shown in FIG. 11a, route points (1111)-(1116) are classified as relevant to user location (1120), but route point (1117) is excluded from the list of relevant route points.

An alternative set of rules for determining which points are relevant to user location (1120 may, for example, consider neighboring tiles (see FIG. 11b) instead of tiles that intersect with the vicinity square (1150). Referring to FIG. 11b, tiles (1151)-(1154) are highlighted, as well as five additional tiles (1161)-(1165) that border tile (1153) in which user location (1120 is found. Using all nine of the corresponding tile-ID coordinates as keys, and using relevance rules (a)-(c), look-up table (610) returns all seven route points (1111)-(1117) as relevant. Although the method depicted in FIG. 11b may, for some cases, yield more points than are necessary, it does not require the extra step of determining which tiles are in vicinity of user location (1120).

### Example Client-Server Protocol for Spatial Sorting Optimization

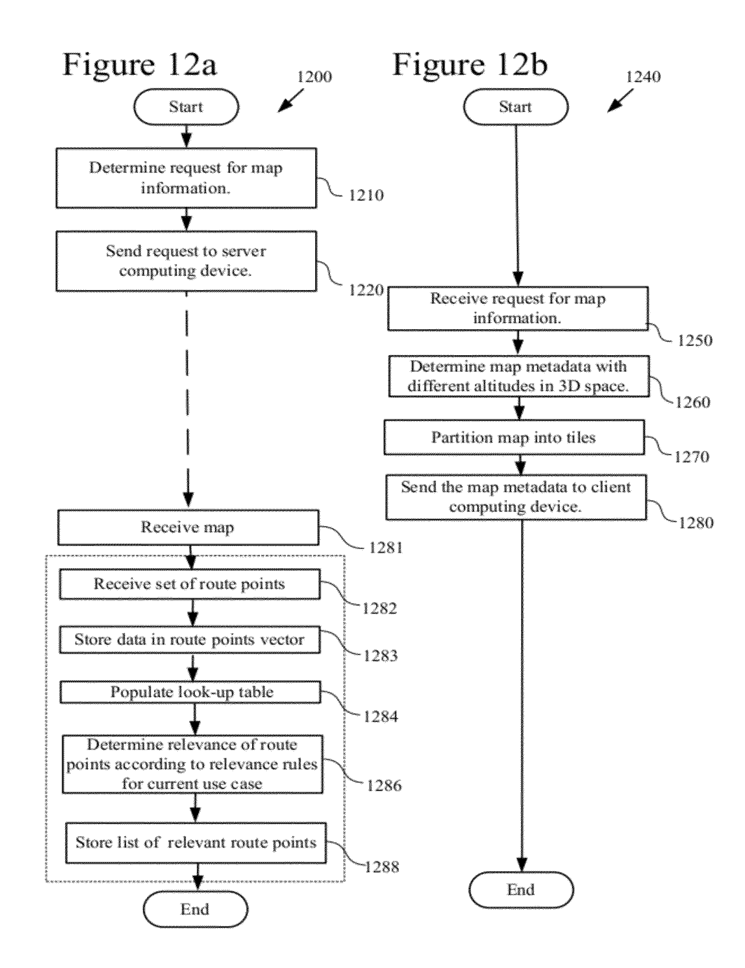

With reference to FIGS. 12a-12b, a generalized spatial sorting optimization technique for navigating a route, using, for example, a GPS-equipped mobile electronic device, is presented in accordance with the description provided above. A remote computer capable of geographic mapping may supply map data and/or location data to the mobile devices. The remote computer may be located on a satellite or it may be ground-based. The remote computer may function as an intermediary between a GPS satellite and a mobile device to assist in calculating the location of the mobile device, or the location determination may be made within the mobile device.

Within a “client-server” configuration, the remote computer may be considered a “server” and a mobile computing device may be considered a “client.” FIG. 12a includes method steps (1200) performed by the client and FIG. 12b includes method steps (1240) performed by the server. To start, a navigation tool implemented on the client computing device formulates a request for map information (1210) and sends the request to the server (1220). The server receives the request (1250), gathers the requested map data (1260), partitions the map into tiles (1270), and sends the map data to the client (1280). The client receives the map (1281) from the server as well as a set of route points associated with the route (1282), which begins the process of spatial sorting (as shown in dashed lines in FIG. 12a) to optimize use of computing resources while processing the map data. The map data is stored (1283) in the form of a complete set of route points, in Route Points Vector (620). The look-up table (610) is then populated (1284) with tile-IDs according to a set of relevance rules based upon one or more use cases. When a new location needs to be rendered, or a navigation activity requires processing data for a new location, relevance of the route points with respect to each tile that the route intersects is determined (1286) and a subset of relevant route points is selected (1288) according to the relevance rules. The subset of relevant route points (660) is then stored in step (1290). Steps (1282)-(1290), which implement the spatial sorting function of the mobile device (100) may then be repeated if additional navigation or rendering tools are invoked to process route points on the same map.

Although FIGS. 12a and 12b show acts of a single client computing device and single server computing device, one server computing device can service requests from multiple client computing devices. Moreover, a given client computing device can select between multiple server computing devices. Server processing can be stateless, or a server computing device can remember state information for specific client computing devices from request to request.

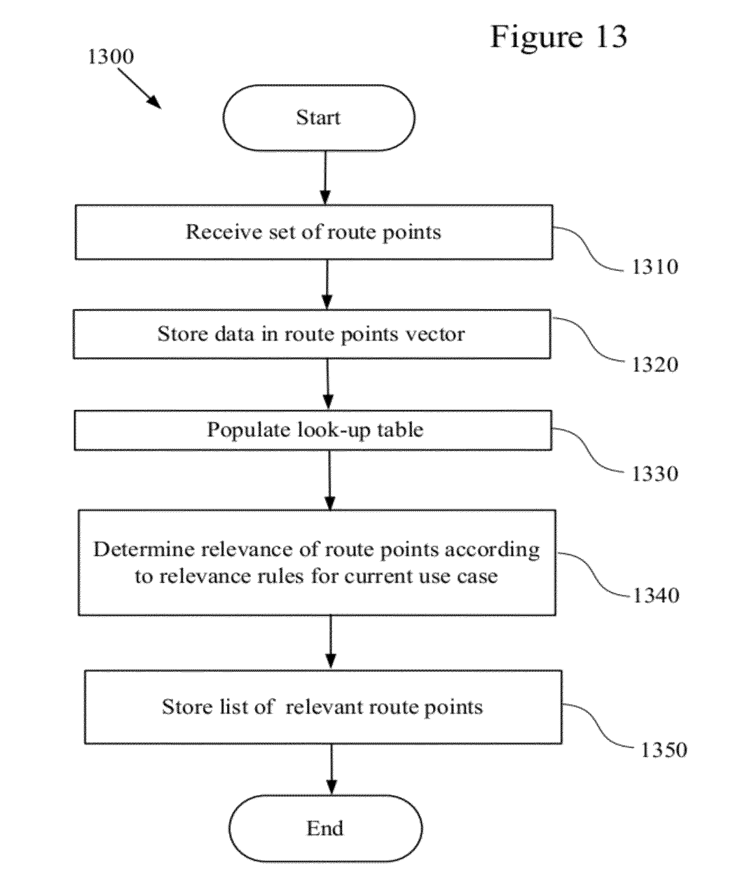

The spatial sorting method steps within the dashed lines of FIG. 12a, for implementation on the mobile device, are presented separately in FIG. 13. To optimize navigation along a prescribed route shown on a digital map, the mobile device first receives a full set of route points associated with the prescribed route (1310). The full set of route points is then stored in memory as a route points vector (1320). The digital map is partitioned into a plurality of tiles so that a look-up table can be populated with a set of keys (1330), in which each key is associated with a different tile. Then, the mobile device determines which route points, of the full set of route points, are relevant to a certain tile, according to a set of relevance rules (1340). Finally, the list of relevant route points is stored (1350) so that during the map rendering process, this reduced set of route points can be processed instead of processing the entire route points vector.

### Alternatives and Variations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media (e.g., non-transitory computer-readable media, such as one or more optical media discs such as DVD or CD, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

The disclosed methods, apparatus, and systems should not be construed as limiting in any way. Instead, the present disclosure is directed toward all novel and non-obvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method, implemented by a mobile electronic device, of optimizing navigation along a prescribed route shown on a digital map, the method comprising:
by use of a mobile electronic device,
receiving a full set of route points associated with the prescribed route;
storing the full set of route points in a memory as a route points vector;
populating a look-up table with a set of keys, wherein the digital map is partitioned into a plurality of tiles, and wherein each key is associated with a different one of the plurality of tiles;
determining which route points, of the full set of route points, are relevant to each of one or more tiles of the plurality of tiles, wherein the determining is based on a set of relevance rules; and
storing the relevant route points for each of the one or more tiles.

2. The method of claim 1, wherein the relevance rules include:
a rule indicating that a pair of route points are relevant to a tile if a route segment connecting them intersects the tile;
a rule indicating that a pair of route points are relevant to a tile if the route segment connecting them intersects one or more edges of the tile;
a rule indicating that a plurality of route points are relevant to a tile if the route segment connecting them leaves and re-enters the tile; and
a rule indicating that a route point in a vicinity of a tile is relevant to the tile.

3. A method, implemented at least in part by a mobile device, of efficiently navigating a prescribed route shown on a digital map, the method comprising:
determining a current location of the mobile device using GPS location information;
selecting map data based at least in part on the GPS location information, wherein the map data comprises a digital map and a route;
rendering the map and the current location of the mobile device for display on the mobile device using spatial sorting optimization; and
tracking progress along the route using spatial sorting optimization.

4. The method of claim 3, wherein the map data is stored on a remote server.

5. The method of claim 3, wherein the route is defined by a full set of route points, and wherein rendering the digital map and the current location comprises:
for each of a plurality of tiles on the map,
selecting a subset of route points that are relevant to the tile; and
processing the subset of selected route points.

6. The method of claim 5, wherein processing the subset of selected route points increases computational efficiency compared with processing the full set of route points.

7. The method of claim 5, wherein the full set of route points is stored as an indexed vector; each of the plurality of tiles is stored in a look-up table; and each tile in the look-up table is associated with a list of relevant route points.

8. The method of claim 5, wherein selecting a subset of route points is done according to relevance rules comprising:
a rule indicating that a pair of route points are relevant to a tile if a route segment connecting them intersects the tile;
a rule indicating that a pair of route points are relevant to a tile if the route segment connecting them intersects one or more edges of the tile;
a rule indicating that a plurality of route points are relevant to a tile if the route segment connecting them leaves and re-enters the tile; and
a rule indicating that a route point in a vicinity of a tile is relevant to the tile.

9. The method of claim 8, wherein the subset of route points determined by the relevance rules includes locations on and near the route.

10. A mobile electronic device adapted to optimize map navigation of a prescribed route on a digital map, the mobile device comprising:
a processor;
a mobile transceiver for receiving map data and route points, and communicating with a remote device;
a GPS receiver for receiving location data to be processed by the processor; a display on which maps and routes are rendered; and
one or more applications, including a map navigation tool that causes the processor to process the map data;
wherein the map navigation tool is configured to use a spatial sorting technique to partition the digital map into tiles, determine relevance of the route points to the tiles, and to process a subset of route points based on the relevance determination.

11. The mobile electronic device of claim 10, wherein the tiles are polygons.

12. The mobile electronic device of claim 10, wherein the tiles are squares.

13. The mobile electronic device according to claim 10, wherein the map navigation tool is configured with data structures comprising:
a look-up table, implemented as a hash table;
an indexed list of relevant route points for each tile; and
a route points vector storing a full set of route points.

14. The mobile electronic device according to claim 13, wherein the look-up table contains one or more LOD values.

15. The mobile electronic device according to claim 13, wherein the look-up table contains keys configured as map tile identifiers.

16. The mobile electronic device according to claim 13, wherein the route points vector is route-specific and contains latitude and longitude coordinates.

17. The mobile electronic device according to claim 13, wherein the list of relevant route points contains tile-specific route point indices.

18. The mobile electronic device according to claim 13, wherein the map navigation tool is configured to select the subset of route points from the route points vector according to a set of relevance rules.

19. The mobile electronic device according to claim 18, wherein the set of relevance rules comprises:
a rule indicating that a pair of route points are relevant to a tile if a route segment connecting them intersects the tile;
a rule indicating that a pair of route points are relevant to a tile if the route segment connecting them intersects one or more edges of the tile;
a rule indicating that a plurality of route points are relevant to a tile if the route segment connecting them leaves and re-enters the tile; and
a rule indicating that a route point in a vicinity of a tile is relevant to the tile.

20. The mobile electronic device according to claim 11, wherein the device is configured as a smart phone.
